(19) United States
(12) Patent Application Publication
(10) Pub. No.: US 2008/0104143 A1
(43) Pub. Date: May 1, 2008

(54) Method and device for storing data available on the device in a database

(75) Inventors: Kim Huay Khor, Penang (MY); Wooi Po Chang, Penang (MY); Chee Woei Lee, Alor Setar (MY)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: AGILENT TECHNOLOGIES, INC., Loveland, CO (US)

(21) Appl. No.: 11/555,280

(22) Filed: Nov. 1, 2006

(51) Int. Cl. G06F 17/30

(52) U.S. Cl. 707/204

(57) ABSTRACT

A method for storing data available on a computing device in a database is disclosed. The method includes providing a definition file that specifies selected portion of the data for storing in the database and generating a script file using the definition file and the data. The method further includes executing the script file to store the selected portion of the data in the database. A computing device on which the method is implemented is also disclosed.

### BACKGROUND

This invention relates to a method and a device for storing data available on the device in a database. More particularly, the invention relates to a test apparatus on which test results are available which need to be stored in a database.

Testing throughput for a testing apparatus such as an oscilloscope is an important parameter. This is especially so when the testing apparatus is used in a compliance workshop for testing the compliance of a device-under-test (DUT) usually under a tight time constraint. An example of such a workshop is the universal serial bus (USB) Compliance Workshop for certification of USB devices using an oscilloscope as a testing apparatus. During such a workshop, each manufacturer would typically be given a time slot of for example merely forty-five minutes for certification of their USB devices.

Compliance testing of a device at the workshop includes the testing of the device to obtain a set of test results, and the entry of the test results into a database having a field format in accordance with that specified by the USB-Interface Forum (USB-IF). The testing of the device is typically automated. The DUT is connected to the oscilloscope and a test script on the oscilloscope is run to perform a series of tests on the DUT. The results of the tests are stored in as Extensible Markup Language (XML) data in a XML file. This XML data is typically transformed into Hypertext Markup Language (HTML) data for presentation of the test results to a user on a screen of a display of the oscilloscope. Neither the XML data nor the HTML data has the same format as that of the USB-IF database. To populate or update such a database and possibly other user specific databases, the user would be required to print the test results and manually enter the test results into each database. Such a manual entry of the test results is time consuming, tedious and error prone. Moreover, it would add significantly to the overall testing time of each DUT. Consequently, the testing throughput of the oscilloscope is not optimal.

To increase the testing throughput, it is possible to simply import the XML data wholly into databases such as Microsoft Access and Excel to reduce testing time. However, Microsoft Access and Excel will create a table that follows the structure or format of the XML data in entirety and tabulate all the data contained in the XML file. The format of the table is often incompatible with that of the USB-IF database format and thus data in the table cannot be easily transferred into the USB-IF database. Furthermore, not all the tabulated data is necessary; the table therefore contains irrelevant data. A script can be written to extract only relevant data from either the XML file, or the Microsoft Access or Excel file for updating the USB-IF database. However, a script would have to be written, most likely by the manufacturer of the oscilloscope, for each database of a different format.

It is thus desirable to at least provide a user-friendly way to facilitate the storing of relevant test results in the database.

### SUMMARY

The invention may be implemented as a method for storing data available on a computing device in a database. The database may reside on the computing device or on another computing device. The method includes providing a definition file that specifies selected portion of the data for storing in the database and generating a script file using the definition file and the data. The method further includes executing the script file to store the selected portion of the data in the database. The definition file may be a file created using a word processor or text editor. Alternatively, the definition file may be generated by executing a program. In such a case, providing a definition file may include providing a user interface including the data on the computing device. The user is allowed to select, via the user interface, the portion of the data for storing. The definition filed is then generated based on the user's selection. The data may be in an Extended Markup Language (XML) format. For such a data format, generating the definition file includes generating an Extensible Stylesheet Language Transformations (XSLT) template based on the user's selection, and generating a script file includes generating a structured query language (SQL) script file using the XSLT template and the data. The SQL script may be generated by using an XSL Transform class to process the XSLT template. According to one embodiment, the computing device includes a test apparatus, and the data includes test results obtained using the test apparatus.

According to another implementation of the invention, there is provided a computing device in which the above described method is implemented. The computing device includes, but is not limited to, a personal computer, a personal digital assistance and a test apparatus. Accordingly, the computing device includes a means for generating a script file using a definition file and the data, wherein the definition file specifies selected portion of the data for storing in a database, and a means for executing the script file to store the selected portion of the data in the database.

According to another implementation of the invention, there is provided a program storage device readable by the above described computing device. The program storage device tangibly embodies a program of instructions that is executable by the computing device to perform the above described method for storing data available on the computing device in a database.

Other aspects and advantages of the invention will become apparent from the following detailed description, taken in conjunction with the accompanying drawings, illustrating by way of example the principles of the invention.

### BRIEF DESCRIPTION OF DRAWINGS

The invention will be better understood with reference to the drawings, in which:

FIG. 1 is a schematic drawing of a testing apparatus according to an embodiment of the invention;

FIG. 2 is a flowchart showing a sequence of steps for storing test results available on the test apparatus in FIG. 1 in a database;

FIG. 3 is a drawing of a command selection menu used in the sequence in FIG. 2;

FIG. 4 is a drawing of a dialog box used in the sequence in FIG. 2 for allowing a user to select test results for the generation of an XSLT template that is used subsequently to generate a script file; and

FIG. 5 is a drawing of a dialog box used in the sequence in FIG. 2 for executing the script file in FIG. 4.

### DETAILED DESCRIPTION OF THE EMBODIMENTS

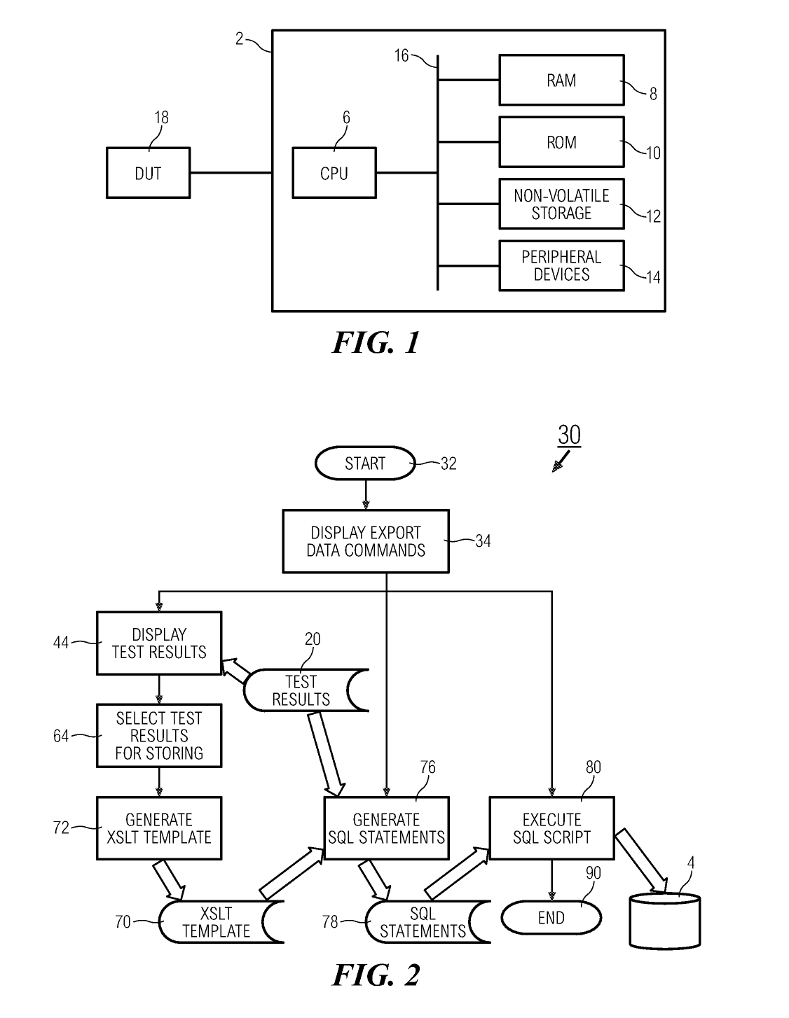

As shown in the drawings for purposes of illustration, the invention is embodied in a novel testing apparatus and method for storing test results available on a testing apparatus in a database. Existing testing apparatus and methods have suffered from long overall test time due to the manual entry of selected test results in a database. The manual entry of the test results is also error prone. Referring to FIG. 1, a testing apparatus, such as an oscilloscope 2 embodying the invention allows a user to select, on the oscilloscope 2, at least a portion of the test results for storing in a database 4 (FIG. 2), and stores the selected portion of the test results in the database 4 without the need for any manual entry of data into the database 4.

Generally, the oscilloscope 2 includes a central processing unit (CPU) 6 that is coupled to a random access memory (RAM) 8, a read only memory (ROM) 10, a non-volatile storage unit 12 and other peripheral devices 14 via a bus 16. The bus 16 carries data signals, control signals and power to the various components of the oscilloscope 2. The non-volatile storage unit 12 may be a floppy disk, a compact disc (CD), a chip card or a hard disk. The other peripheral devices 14 include a display, a keyboard, and a mouse (all not shown). The display may be a video display, LCD display, touch-sensitive display, or other display. The ROM 10 or the non-volatile storage unit 12 may serve as a program storage device for storing a program of instructions that is executable by the CPU 6 for automated testing of a device-under-test (DUT) 18, and another program of instructions for exporting or storing results of the test into the database 4 having at least one table. The database 4 is either created or loaded into the non-volatile storage unit 12. In other embodiments, the database may be stored on a separate device external to the oscilloscope 2 but connected thereto, for example, via a local area network (LAN). The data export program is implemented using the C#.NET programming language (an object-oriented programming language developed by Microsoft as part of their .NET initiative), although other high level or low level programming languages may also be used. Both the test program and the data export program are stored in a base directory.

During use, the oscilloscope 2 is connected to a DUT 18 as shown in FIG. 1 for compliance testing of the DUT 18. The test program is executed by the CPU 6 for carrying out a number of tests on the DUT 18. The tests may for example be those specified in the USB-IF Device High-Speed Electrical Test Procedure for verifying electrical parameters of the physical layer of the DUT 18. The CPU 6 displays a window (not shown) that indicates the status of the test. The CPU 6 stores the test results as XML data in a XML file 20 (FIG. 2), report.xml, in a DUT specific directory under the base directory.

Once testing of the DUT 18 is completed, the user activates a command button (not shown) in the test window to invoke the data export program to start a sequence 30 of steps for storing the test results in a table in the database 4. In other words, the test results are exported to the database 4. Alternatively, the data export program may be automatically invoked at the end of the test program.

When invoked, the sequence 30 as shown in FIG. 2 starts in a START step 32, wherein the CPU 6 executes the instructions of the data export program. Hereafter, for ease of description, the CPU 6 is simply described to be performing an action although it is known that the CPU 6 has to execute the relevant instructions in the program in order to do so.

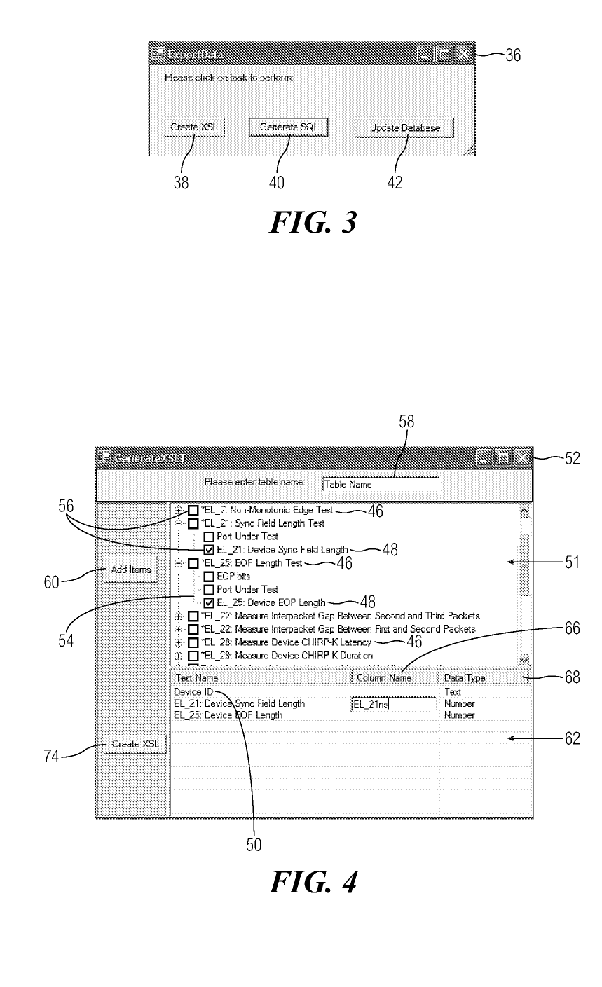

The sequence 30 next proceeds to a DISPLAY EXPORT DATA COMMANDS step 34, wherein the CPU 6 displays a command selection menu 36 (FIG. 3) on a screen (not shown) of the display. The menu 36 includes three user-activatable buttons 38, 40, 42 for invoking respective commands. The commands include “CREATE XSL”, “GENERATE SQL” and “UPDATE DATABASE” commands. The “CREATE XSL” command is invoked for creating a definition file, such as an Extensible Stylesheet Language Transformations (XSLT) template 70, from the XML file 20. This command needs to be invoked only once for a particular type of test results file. The XSLT template 70 contains user-selected test results. Once the XSLT template 70 is created, it can be used for the same type of test results files for other DUTs. The “GENERATE SQL” command is invoked to transform the XML file 20 into a set of SQL commands using the XSLT template 70 created earlier and the XML file 20. In other words, the “GENERATE SQL” command is invoked to generate a script file containing the SQL commands. The “UPDATE DATABASE” command is invoked to execute the script file, or more specifically the SQL commands, for updating the table in the database 4 with the selected test results.

The sequence 30 next proceeds to a DISPLAY TEST RESULTS step 44, when the user selects the “CREATE XSL” command. In this step 44, the CPU 6 parses the data in the XML file 20, report.xml, to compile a list of test names 46, and test results 48 associated with each test name 46. The CPU 6 ignores or filters irrelevant data in the XML file 20, such as references to graphic files. The XML file 20 also includes a Device ID 50. The CPU 6 displays the test names 46 and test results 48 in a tree like structure in a suitable user interface, such as a test-results panel 51 in a test results dialog box 52 as shown in FIG. 4. Each test name 46 is displayed at the far left hand side of the test-results panel 51 and the test results 48 associated with the test name 46 are displayed indented to the right thereof. Dotted lines 54 link each of the test results 48 to the respective test name 46 to further show their association. Appended to the left of each test name 46 and each test result 48 is a check box 56. The CPU 6 also displays a “table name” field 58 above the test-results panel 51 for the user to enter the name of the table in the database 4 to which selected test results 48 are to be stored. The CPU 6 also displays a user-activatable “Add Items” button 60 to the left of the test-results panel 51. The CPU 6 further displays the Device ID 50 in a selected-test-results panel 62 below the test-results panel 51.

The sequence 32 proceeds to a SELECT TEST RESULTS FOR STORING step 64. In this step 64, the user may select, on the oscilloscope 2, at least a portion of the test results 48 for storing in the database 4. To do so, the user enters the table name in the table name field 58, and selects the test results 48 that are required for updating the table by checking off the appropriate check boxes 56 using the mouse. Once the required test results 48 have been selected, the user activates the “Add Items” button 60 and the CPU 6 adds the selected test results 48 to the selected-test-results panel 62 by displaying each test result 48 in a row of a list. Against each selected test result 48, the user enters the column or field name 66 in the table to which the selected test result 48 is to be stored. When displaying the selected test result 48, the CPU 6 also displays the data type 68 of the selected test result 48 as indicated in the XML file 20, report.xml. The user has the option to modify this data type 68 to match that in the table. A dropdown menu (not shown) may be provided for such a purpose. After the required test results 48 are selected, the user is then ready to generate a corresponding XSLT template 70. In this manner, selected test results 48 may be exported to a database having any field names.

The sequence 30 next proceeds to a GENERATE XSLT TEMPLATE step 72 when the user activates a “CREATE XSLT” button 74 to the left of the selected-test-results panel 62. In response to this user activation, the CPU 6 checks if a field name 66 is entered for each of the selected test results 48 and prompts the user to enter any missing field name 66. When all the required field names 66 have been entered, the CPU 6 uses the selected test results 48 and the table name in the test results dialog box 52 to generate a definition file, more specifically an XSLT template file 70. The user would be prompted to enter a name for this XSLT template file 70. The CPU 6 stores the XSLT template file in the base directory. Thereafter, the CPU 6 closes the test results dialog box 52 and displays once again the command selection menu 36 on the screen.

An example of the XSLT template file 70 that is generated for the selected test results shown in FIG. 4 is as follows:

```
<xsl:stylesheet
    xmlns:xsl=“http://www.w3.org/1999/XSL/Transform”
    version=“2.0”>
  <xsl:output method=“text” indent=“yes” />
  <xsl:variable name=“quote”>’</xsl:variable>
  <xsl:variable name=“equal”>=</xsl:variable>
  <xsl:variable name=“table”>[Table Name]</xsl:variable>
  <xsl:variable name=“sn”>BarCode</xsl:variable>
- <xsl:template match=“ComplianceReporter”>
- <xsl:for-each
    select=“ReportHeader/HeaderGroups/HeaderGroup/HeaderItems
    /HeaderItem[Name=‘Device ID’]”>
  <xsl:variable name=“deviceid” select=“Value” />
  <xsl:value-of select=“concat(‘INSERT INTO ’, $table, ‘ (‘, $sn,’)
    VALUES (‘, $quote, $deviceid, $quote, ’);’)” />
  <xsl:value-of select=“concat(‘UPDATE ’, $table, ‘ SET [‘, $sn, ’] = ’,
    $quote, $deviceid, $quote)” />
    </xsl:for-each>
  <xsl:apply-templates
    select=“TestResults/Result/OverallReferences/Reference” />
- <xsl:for-each
    select=“ReportHeader/HeaderGroups/HeaderGroup/HeaderItems
    /HeaderItem[Name=‘Device ID’]”>
  <xsl:variable name=“deviceid” select=“Value” />
  <xsl:value-of select=“concat(‘ WHERE ’, $sn, ‘ = ’, $quote,
    $deviceid, $quote, ‘;’)” />
    </xsl:for-each>
    </xsl:template>
- <xsl:template
    match=“TestResults/Result/OverallReferences/Reference”>
  <xsl:variable name=“testname” select=“ActualDescriptor” />
- <xsl:choose>
- <xsl:when test=“$testname=‘EL_21: Device Sync Field Length’”>
  <xsl:value-of select=“‘, ’” />
  <xsl:variable name=“column”>EL_21ns</xsl:variable>
- <xsl:choose>
- <xsl:when test=“DoubleActualValue=‘INF’”>
  <xsl:value-of select=“concat(‘[‘, $column, ’]’, $equal, $quote,
    999999, $quote)” />
    </xsl:when>
- <xsl:otherwise>
  <xsl:value-of select=“concat(‘[‘, $column, ’]’, $equal, $quote,
    DoubleActualValue, $quote)” />
    </xsl:otherwise>
    </xsl:choose>
    </xsl:when>
- <xsl:when test=“$testname=‘EL_25: Device EOP Length’”>
  <xsl:value-of select=“‘, ’” />
  <xsl:variable name=“column”>EL_22ns</xsl:variable>
- <xsl:choose>
- <xsl:when test=“DoubleActualValue=‘INF’”>
  <xsl:value-of select=“concat(‘[‘, $column, ’]’, $equal, $quote,
    999999, $quote)” />
    </xsl:when>
- <xsl:otherwise>
  <xsl:value-of select=“concat(‘[‘, $column, ’]’, $equal, $quote,
    DoubleActualValue, $quote)” />
    </xsl:otherwise>
    </xsl:choose>
    </xsl:when>
    </xsl:choose>
    </xsl:template>
    </xsl:stylesheet>
```

An XSLT template is created for each unique table in a database. This XSLT template needs only be created once. If the XSLT template has not been created, the customer will have to select the “Create XSLT” button 38 in the command selection menu 36 to create the XSLT template. In other words, the user can create different XSLT templates for storing different portions of the XML test results into different tables of one or more databases. For example, the XML data may contain the entire test results for all three USB test categories, host, hub and device tests required under the USB Compliance Testing. A subset of the test results of each of these test categories is required to be stored in a corresponding table in the database. In such a case, the user can create one XSLT template for each test category. All XSLT template files are stored in the base directory.

Next, the sequence 32 proceeds to a GENERATE SQL STATEMENTS step 76 when the user selects the “GENERATE SQL” button 40 on the command selection menu 36. In this step 76, the CPU 6 uses the test results in the XML file 20 and an XSLT template 70 selected from those stored in the base directory, to transform the XML file 20 into a set of SQL statements, which are collectively known as a script or script file. These SQL statements are specific to each XML file 20. The CPU 6 uses the XslTransform class in .NET to transform the XML file 20, report.xml, into SQL statements using the XSLT template 70 generated earlier. The XslTransform class is the XSLT processor provided by Microsoft .NET Framework for performing XML transformations. The instructions for implementing this GENERATE SQL STATEMENTS step 76 are as follows:

```
private void btnSQL_Click(object sender, System.EventArgse)
{
  try
  {
    System.IO.StreamReader sr = null;
    sr = new System.IO.StreamReader(“report.xml”);
    sr.ReadLine( );//skip xml declaration line
    //Create a new XslTransform object.
    XslTransform xslt = new XslTransform( );
    //Load the stylesheet.
    xslt.Load(“db.xsl”);
    //Create a new XPathDocument and load the XML data
to be transformed.
    XPathDocument mydata = new XPathDocument(sr);
    sr.Close( );
    //Create an XmlTextWriter which outputs to a
console.
    XmlWriter writer = new
XmlTextWriter(“report.txt”,System.Text.Encoding.Unicode);
    //Transform the data and send the output to the
console.
    xslt.Transform(mydata,null,writer, null);
    writer.Close( );
  }
  catch (Exception msg)
  {
    MessageBox.Show(msg.Message);
  }
}
```

The generated SQL statements are stored in a text file, report.txt. This text file is also referred to as a script file 78. The script file 78, report.txt, is stored in the DUT specific directory together with the XML file 20, report.xml. A script file is generated for each XML file 20. An example of a script file 78, report.txt, corresponding to the XML file 20, report.xml, may be as follows, depending on the selected test results:

INSERT INTO [High Speed] (Barcode) VALUES (‘T123456’);
UPDATE [High Speed] SET [EL_6]=‘Pass’, [EL_2]=‘Pass’,
[EL_5]=‘Pass’, [EL_7]=‘Pass’,
[EL_21ns]=‘66.6341323852539’,
[EL_25ns]=‘17.19849967956543’, [EL_22ns]=‘341.69921875’,
[EL_28 Chirp K Starts value]=‘3223.619873046875’, [EL_29
value]=‘2.0001349449157715’, [EL_31
value]=‘3.6736018657684326’, [EL_38
value]=‘3.0016651153564453’, [EL_40]=‘FOUND’ WHERE
Barcode = ‘T123456’;

The user can choose between performing the transformation and updating the database 4 with the selected test results of a DUT 18 immediately after testing each DUT 18 or to compile and execute the SQL scripts for all DUTs after all the DUTs are tested.

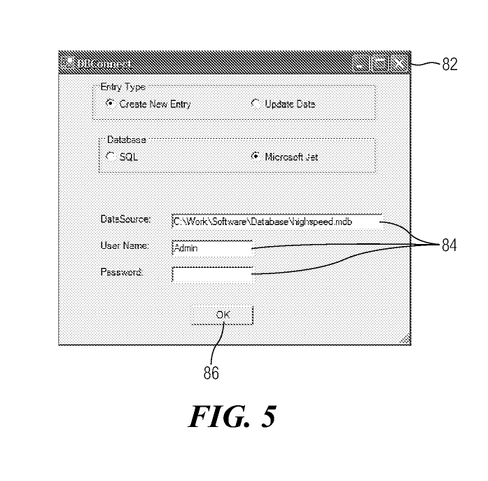

The sequence 30 next proceeds to an EXECUTE SQL SCRIPT step 80, when the user activates the “UPDATE DATABASE” button 42 in the command selection menu 36. The CPU 6 causes a database update dialog box 82, as shown in FIG. 5, to pop up on the screen for the user to enter database information such as data source, user name and password, in respective fields 84 in the database update dialog box 82. These information are stored in a registry on the oscilloscope 2 for subsequent use so that the user need only to key in these information once. In the database update dialog box 82, the user is required to choose between “Create new entry” and “Update data” when updating the table of the database 4.

The user will need to check off one option to indicate whether a new entry is to be created in the database 4 or to update an existing entry if the Device ID 50 of the DUT 18 has been previously entered into the table. In the USB compliance workshop, the Device IDs of the DUTs are typically entered into the table of the database 4 before testing begins. If the user selects “Create New Entry”, the INSERT statement in the SQL script will be executed to insert the Device ID 50 first. If user selects “Update Database”, the INSERT statement will be skipped and the UPDATE statement will be executed to update the entry in the database identified by the Device ID 50. The option selected will also be stored into the registry and used as a default option the next time the “UPDATE DATABASE” command is selected.

Once the necessary information is entered and the appropriate option selected, the user clicks on an “OK” button 86 in the database update dialog box 82 to initiate the database update. This action causes the CPU 6 to use the .NET System.Data.OleDb namespace and System.Data.SqlClient namespace to run the script file 78 to access and update the database 4. The sequence 30 ends in an END step 90. In this manner, selected portion of the test results 48 is stored in the database 4.

Advantageously, using the above described method of storing test results available on an oscilloscope 2 in a database 4 allows relevant data to be stored in the database 4. Furthermore, once the XSLT template 70 and script file 78 have been created, entry of the test results into the database 4 will be completed instantaneously and without error. There is no need for any manual entry of the test results, which was required in the prior art. Consequently, the overall test time required for testing a DUT 18 is greatly reduced and the testing throughput increases accordingly. The number of DUTs that can be tested during the compliance workshop also increases; more customers can be supported in a lesser amount of time. Any change in the XSLT template 70 can be easily made using any text editor and the modified XSLT template 70 does not need to be compiled. The SQL script 78 can be executed using the export data program or by using a tool such as the on-line structured query language (OSQL) or custom code written by the user.

Although the present invention is described as implemented in the above described embodiment, it is not to be construed to be limited as such. For example, generating a script file 78 need not be carried out according to the above described method using the XSLT template 70 and XSLTransform class. A dedicated application may use the selected portion of the test results specified in a user provided definition file to generate the same script file 78.

As another example, the data export method may also be implemented in other testing apparatus and not just limited to the oscilloscope described above. The method may also be implemented as a standalone program that is executable on any computing device.

As yet a further example, the invention is also not limited to test results stored in an XML file as described above. The invention is applicable also to test results in other formats, such as the comma-delimited format, which is also known as comma-separated values (CSV).

What is claimed is:

1. A method of storing data available on a computing device in a database, the method comprising:
providing a definition file that specifies selected portion of the data for storing in the database;
generating a script file using the definition file and the data; and
executing the script file to store the selected portion of the data in the database.

2. A method according to claim 1, wherein providing a definition file comprises:
providing a user interface including the data on the computing device;
allowing a user to select, via the user interface, the portion of the data for storing; and
generating the definition file based on the user's selection.

3. A method according to claim 2, wherein the data are in an Extended Markup Language (XML) format and wherein generating the definition file based on the user's selection comprises generating an XSLT template based on the user's selection, and generating a script file comprises generating a structured query language (SQL) script file using the XSLT template and the data.

4. A method according to claim 3, wherein generating an SQL script file using the XSLT template and the data comprises generating the SQL script file using a XSLTransform class to process the XSLT template.

5. A method according to claim 1, wherein the computing device comprises a test apparatus, and wherein the data comprises test results.

6. A computing device having data stored thereon, the computing device comprising:
means for generating a script file using a definition file and the data, wherein the definition file specifies selected portion of the data for storing in a database; and
means for executing the script file to store the selected portion of the data in the database.

7. A computing device according to claim 6 further comprising:
means for providing a user interface including the data on the computing device;
means for allowing a user to select, via the user interface, the portion of the data; and
means for generating the definition file based on the user's selection.

8. A computing device according to claim 7, wherein the data are in an Extended Markup Language (XML) format and wherein the means for generating the definition file based on the user's selection comprises means for generating an XSLT template based on the user's selection and the means for generating a script file comprises means for generating an SQL script file using the XSLT template and the data.

9. A computing device according to claim 8, wherein the means for generating a script file using the XSLT template comprises means for generating the SQL script file using a XSLTransform class to process the XSLT template.

10. A computing device according to claim 6, wherein the computing device comprises a test apparatus, and wherein the data comprises test results.

11. A program storage device readable by a computing device, tangibly embodying a program of instructions, executable by the computing device to perform a method for storing data available on the computing device in a database, the method comprising:
providing a definition file that specifies selected portion of the data for storing in the database;
generating a script file using the definition file and the data; and
executing the script file to store the selected portion of the data in the database.

12. A program storage device according to claim 11, wherein providing a definition file that specifies selected portion of the data for storing in the database comprises:
providing a user interface including the data on the computing device;
allowing a user to select, via the user interface, the portion of the data for storing; and
generating the definition file based on the user's selection.

13. A program storage device according to claim 12, wherein the data are in an Extended Markup Language (XML) format and wherein generating the definition file based on the user's selection comprises generating an XSLT template based on the user's selection, and generating a script file comprises generating a structured query language (SQL) script file using the XSLT template and the data.

14. A program storage device according to claim 13, wherein generating an SQL script file using the XSLT template and the data comprises generating the SQL script file using a XSLTransform class to process the XSLT template.
